(19) United States
(12) Patent Application Publication
(10) Pub. No.: US 2025/0131737 A1
(43) Pub. Date: Apr. 24, 2025

(54) METHOD TO HANDLE IMPACT EVENTS WHEN PASSING THROUGH SPEED BUMPS AND SYSTEM FOR THE SAME

(71) Applicants: HYUNDAI MOTOR COMPANY, SEOUL (KR); KIA CORPORATION, SEOUL (KR)

(72) Inventor: Sung Hwan JUN, Hwaseong-si (KR)

(21) Appl. No.: 18/824,308

(22) Filed: Sep. 4, 2024

(30) Foreign Application Priority Data
Oct. 23, 2023 (KR) 10-2023-0141943

(51) Int. Cl. G06V 20/58; G06T 7/50; G06V 20/56; G07C 5/02; G08G 1/16

(52) U.S. Cl. CPC G06V 20/58; G06T 7/50; G06V 20/588; G07C 5/02; G08G 1/166; G06T 2207/30261

(57) ABSTRACT

According to the present disclosure, a G value equal to or higher than threshold, which is a reference point of recording an impact event, may be bypassed at the time when a vehicle passes over a speed bump ahead on the path on which the vehicle is driving to prevent recording of impact events, so that the impact event resulting from an impact caused by the speed bump may be disregarded at the time when the vehicle passes over the speed bump after the speed bump has been perceived, thereby preventing unnecessary videos from being stored in a memory.

### CROSS-REFERENCE TO RELATED APPLICATION

The present application claims priority to Korean Patent Application No. 10-2023-0141943, filed on Oct. 23, 2023, the entire contents of which is incorporated herein for all purposes by this reference.

### TECHNICAL FIELD

The embodiments of the present disclosure relate to a method of handling an impact event when passing over a speed bump and a system therefor.

### BACKGROUND

The statements in this section merely provide background information related to the present disclosure and may not constitute prior art.

As the automobile industry has developed, automobiles have become commercialized to the extent that it is said that the era of one car per household has arrived, and various vehicle-related accidents such as collision accidents, theft of parked vehicles, and vehicle damage including scratches caused by others occur frequently.

As such vehicle accidents occur frequently, it has recently become common for vehicles to be equipped with a device for recording videos, also known as a black box in Korea. In other words, a user can determine the circumstances of a vehicle accident through videos recorded by a camera and stored in the device for recording videos to determine who is responsible for a crash accident, secure the identity of a car thief, or find out what damage has been done to a vehicle.

In addition, as consumer demand grows and related technology develops, a 4-channel (front, rear, left, and right) camera or a high-definition camera such as a full-HD level camera has been installed in a device for recording videos along with a large-capacity flash memory for storing a number of videos.

Furthermore, various convenient functions, such as a displaying function to allow users to view videos captured by a camera while they are being recorded and a function to transmit videos captured by a camera to a smartphone, have also been added to devices for recording videos.

Meanwhile, a conventional device for recording videos can operate in a continuous recording mode and an event recording mode.

In the continuous recording mode, all videos captured by a camera are stored in a flash memory or the like, while power is supplied to a device for recording videos. For example, when a device for recording videos is connected to a vehicle battery for power supply, in the continuous recording mode, captured videos are stored all the time regardless of whether the vehicle is running or parked.

In the event recording mode, not all videos are saved. Instead, a camera is driven to record videos continuously, and, when an impact value equal to or higher than threshold is sensed by a G-sensor to determine whether an impact has occurred, the videos recorded at the time are stored in a flash memory, or the like.

In the aforementioned continuous recording mode of the conventional technology, it is possible to obtain all videos of vehicle-related accidents such as collision accidents, vehicle theft, and vehicle damage (hereinafter, collectively referred to as “vehicle accidents”). However, in the continuous recording mode, a vehicle battery may be discharged, storage capacity may be insufficient as many videos are stored, and important video data may be lost by overwriting the existing video data with new video data.

In particular, in the continuous recording mode of the conventional technology, since a huge amount of video data is stored, the lifespan of a flash memory, where a limited number of data writes are possible, is shortened. Therefore, in order to secure videos of vehicle accidents, consumers need to replace a flash memory every 6 months to 1 year and 6 months, which is expensive and cumbersome.

In addition, in the event recording mode of the conventional technology, when an impact occurs, the video of the impact is saved, making it possible to use a flash memory more efficiently than in the continuous recording mode. However, in the event recording mode, videos recorded after a G-sensor has sensed an impact are stored in a flash memory, making it impossible to obtain videos recorded before a vehicle accident has occurred.

For example, in the case of car damage where someone else has scratched a car (e.g., with a nail), according to the conventional technology, it is only possible to obtain videos recorded after the car has been scratched. That is, it is not possible to obtain evidence to determine the overall circumstances of vehicle damage, such as a video showing what happens around the car before/at/after the time when the car has been scratched, a video showing who is approaching the car to scratch it, and a video showing how the car has been scratched.

Therefore, in recent years, a range of technologies have been developed to obtain videos recorded before, at, and/or after the time a vehicle accident has occurred and to solve problems such as the discharge of a vehicle battery, an insufficient storage capacity, the loss of important video data, and the shortened lifespan of non-volatile storage media resulting from a limited number of data writes.

Apart from the above-described technology for recording videos for vehicles, speed bumps are installed on roads where vehicles are required to travel slowly to limit the speed of the vehicles, and the speed bumps are useful in many ways in terms of safe operation of vehicles and protection of pedestrians.

However, the occupants of a vehicle passing over a speed bump may experience a significant impact, which may vary depending on the speed at which the vehicle is traveling. Moreover, it often happens that the G-sensor of the device for recording videos of the vehicle passing over the speed bump senses an impact and switches to the event recording mode.

Therefore, when a G value equal to or higher than a certain reference point according to a set sensitivity to impact has been applied to a vehicle, the impact is recorded, and the captured video is stored in a memory. As a result, even under normal driving conditions, videos of actual accidents that should be saved first are often deleted due to limited memory capacity as too many videos of impacts are stored in areas with a lot of speed bumps, such as children's protection zones or country roads, lowering consumer trust.

The information included in this Background of the present disclosure section is only for enhancement of understanding of the general background of the present disclosure and may not be taken as an acknowledgement or any form of suggestion that this information forms the prior art already known to a person skilled in the art.

### SUMMARY

One embodiment of the present disclosure is aimed at resolving the above-described problems.

An embodiment of the present disclosure is aimed at providing a method of recording videos around a vehicle and a system therefor, where a G value equal to or higher than threshold, which is a reference point of recording an impact event, may be bypassed at the time when a vehicle passes over a speed bump ahead on the path on which the vehicle is driving to prevent recording of impact events, so that the impact event resulting from an impact caused by the speed bump may be disregarded at the time when the vehicle passes over the speed bump after the speed bump has been perceived, thereby preventing unnecessary videos from being stored in a memory.

A method according to the present disclosure may include activating an event recording mode to record a video around the vehicle as a preset impact event occurs, perceiving a speed bump ahead on a path on which the vehicle is running, predicting a time point when the vehicle passes over the speed bump, and disregarding an impact event for the event recording mode based on the predicted time point.

The perceiving of a speed bump may include obtaining an image of a front view from the vehicle by use of at least one camera and processing the image to determine whether there is a speed bump.

The perceiving of a speed bump may include determining whether there is a speed bump ahead through at least one LIDAR.

The predicting of the time point may include determining a distance between the perceived speed bump and a current location of the vehicle and determining a time point when the vehicle reaches the speed bump based on the calculated distance and a speed of the vehicle.

The disregarding of an impact event may include determining that there is an object expected to approach the vehicle at an earlier time point than the predicted time point.

The disregarding of an impact event may further include determining that an alert on an approaching or collision-risky object is issued by the vehicle at an earlier time point than the predicted time point.

The disregarding of an impact event may further include determining that there is a sudden stop or start of the vehicle at an earlier time point than the predicted time point.

The determining that there is a sudden stop or start of the vehicle may be based on a variance in a speed of the vehicle.

The disregarding of an impact event according to the present disclosure may include determining that at least one condition is met, and halting the event recording mode, wherein the at least one condition is one of: there being an object expected to approach the vehicle at an earlier time point than the predicted time point; an alert on an approaching or collision-risky object being issued by the vehicle at an earlier time point than the predicted time point; or there being a sudden stop or start of the vehicle at an earlier time point than the predicted time point.

The disregarding of an impact event may comprise ignoring an impact exceeding a reference point for the event recording mode.

A system for recording videos for a vehicle, according to the present disclosure, may include a vehicle speed sensor configured to sense a speed of the vehicle, an impact event sensing module configured to determine whether an impact exceeding a reference point has occurred in the vehicle, a video recording module configured to store videos obtained by at least one camera, an advanced driver assistance system configured to predict risks that are likely to occur to the vehicle, and a control module configured to: activate an event recording mode to record a video around the vehicle as an impact event occurs; perceive a speed bump ahead on a path on which the vehicle is running and predict a time point when the vehicle passes over the speed bump; and disregard an impact event for the event recording mode based on the predicted time point.

The control module may be further configured to process an image of a front view of the vehicle obtained by at least one camera and determine whether there is the speed bump.

The control module is further configured to perceive the speed bump by use of at least one LIDAR configured to scan a front view of the vehicle.

The control module may be further configured to calculate a distance between the perceived speed bump and a current location of the vehicle and calculate a time point when the vehicle reaches the speed bump based on the calculated distance and a speed of the vehicle.

The control module may be further configured to that there is an object expected to approach the vehicle at an earlier time point than the predicted time point.

The control module may be further configured to determine that an alert on an approaching or collision-risky object is issued by the vehicle at an earlier time point than the predicted time point.

The control module may be further configured to determine that there is a sudden stop or start of the vehicle at an earlier time point than the predicted time point.

The control module may be further configured to determine that at least one condition is met, and halt the event recording mode, wherein the at least one condition is one of: there being an object expected to approach the vehicle at an earlier time point than the predicted time point; an alert on an approaching or collision-risky object being issued by the vehicle at an earlier time point than the predicted time point; or there being a sudden stop or start of the vehicle at an earlier time point than the predicted time point.

The control module is further configured to ignore an impact exceeding the reference point for the event recording mode.

Also, as an embodiment of the present disclosure, there is provided a vehicle comprising a vehicle speed sensor configured to sense a speed of the vehicle, an impact event sensing module configured to determine whether an impact exceeding a reference point has occurred in the vehicle, a video recording module configured to store videos obtained by at least one camera, an advanced driver assistance system configured to predict risks that are likely to occur to the vehicle, and a control module configured to: activate an event recording mode to record a video around the vehicle as a preset event occurs; perceive a speed bump ahead on a path on which the vehicle is running and predict a time point when the vehicle passes over the speed bump; and disregard an impact event based on the predicted time point for the event recording mode.

According to an embodiment of the present disclosure, it may be possible to provide the method of handling an impact event when passing over a speed bump and the system therefor, where a G value equal to or higher than threshold, which is a reference point of recording an impact event, may be bypassed at the time when a vehicle passes over a speed bump ahead on the path on which the vehicle is driving to prevent recording of impact events, so that the impact event resulting from an impact caused by the speed bump may be disregarded, thereby preventing unnecessary videos from being stored in a memory.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating the components of a system for handling an impact event when passing over a speed bump according to the present disclosure.

FIG. 2 is a flowchart illustrating the process of handling an impact event when passing over a speed bump according to the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes, will be determined in part by the particularly intended application and use environment.

In the figures, the same reference numerals refer to the same or equivalent parts of the present disclosure throughout the several figures of the drawing.

### DETAILED DESCRIPTION

Because various changes can be made to the present disclosure and a range of embodiments can be made for the present disclosure, specific embodiments will be illustrated and described in the drawings. However, this is not intended to limit the present disclosure to the specific embodiments, and it should be understood that the present disclosure includes all changes, equivalents, and substitutes within the technology and the scope of the present disclosure.

The terms “module” and “unit” used in the present disclosure are merely used to distinguish the names of components, and should not be interpreted as assuming that the components have been physically or chemically separated or can be so separated.

Terms containing ordinal numbers such as “first” and “second” may be used to describe various components, but the components are not limited by the terms. The above-mentioned terms can be used only as names to distinguish one component from another component, and the order therebetween can be determined by the context in the descriptions thereof, not by such names.

The expression “and/or” is used to include all possible combinations of multiple items being addressed. For example, by “A and/or B,” all three possible combinations are meant: “A,” “B,” and “A and B.”

When a component is said to be “coupled” or “connected” to another component, it means that the component may be directly coupled or connected to the other component or there may be other components therebetween.

The terms used herein are only used to describe specific embodiments and are not intended to limit the present disclosure. Expressions in the singular form include the meaning of the plural form unless they clearly mean otherwise in the context. In the present disclosure, expressions such as “comprise” or “have” are intended to indicate the presence of features, numbers, steps, operations, components, parts, or combinations thereof described herein, and should not be understood as precluding the possibility of the presence or the addition of one or more other features, numbers, steps, operations, components, parts, or combinations thereof.

Unless otherwise defined, all terms used herein, including technical or scientific terms, have meanings commonly understood by a person having ordinary skill in the technical field to which the present disclosure pertains. Terms defined in commonly used dictionaries should be interpreted as having meanings consistent with the meanings they have in the context of the relevant technology, and should not be interpreted in an ideal or overly formal sense unless explicitly defined in the present disclosure.

In addition, a unit, a control unit, a control device, or a controller is only a term widely used to name devices for controlling a certain function, and do not mean a generic function unit. For example, devices with these names may include a communication device that communicates with other controllers or sensors to control a certain function, a computer-readable recording medium that stores an operating system, logic instructions, input/output information, etc., and one or more processors that perform operations of determination, calculation, making decisions, etc. required to control the function.

Meanwhile, the processor may include a semiconductor integrated circuit and/or electronic devices that carry out operations of at least one of comparison, determination, calculation, and making decisions to perform a programmed function. For example, the processor may be any one or a combination of a computer, a microprocessor, a CPU, an ASIC, and an electronic circuit such as circuitry and logic circuits.

Examples of a computer-readable recording medium (or simply called a memory) may include all types of storage devices for storing data that can be read by a computer system. For example, they may include at least one of a memory such as a flash memory, a hard disk, a micro memory, and a card memory, e.g., a secure digital card (SD card) or an eXtream digital card (XD card), and a memory such as a random access memory (RAM), a static ram (SRAM), a read-only memory (ROM), a programmable ROM (PROM), an electrically erasable PROM (EEPROM), a magnetic RAM (MRAM), a magnetic disk, and an optical disk.

Such a recording medium may be electrically connected to the processor, and the processor may load and write data from the recording medium. The recording medium and the processor may be integrated or may be physically separate.

Hereinafter, with reference to the attached drawings, a method of handling an impact event when passing over a speed bump and a system therefor according to the present disclosure will be described as follows.

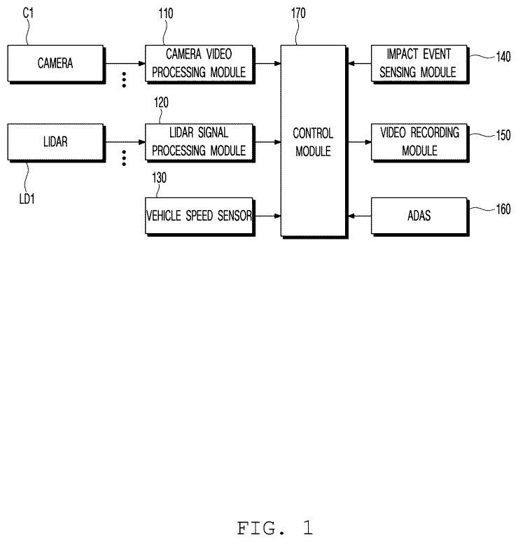

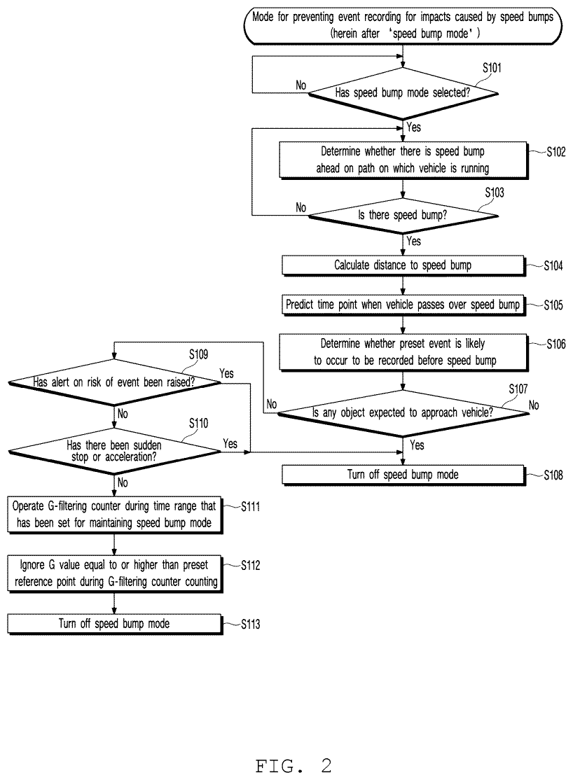

FIG. 1 is a block diagram illustrating the components of a system for handling an impact event when passing over a speed bump according to the present disclosure, and FIG. 2 is a flowchart for illustrating the process of handling an impact event when passing over a speed bump according to the present disclosure.

As shown in FIG. 1, the system for handling an impact event when passing over a speed bump according to the present disclosure may include at least one camera C1, a camera video processing module 110 that analyzes and processes videos obtained by the camera C1, at least one LIDAR LD1, a LIDAR signal processing module 120 that analyzes and processes signals sensed by the LIDAR LD1, a vehicle speed sensor 130 that measures the current driving speed of a vehicle, an impact event sensing module 140 that determines whether an impact exceeding a certain reference point has occurred in the vehicle, a video recording module 150 that stores videos obtained by the camera C1 and processed by the camera video processing module 110 according to a control signal, an advanced driver assistance system 160 (hereinafter, referred to as “ADAS”) that predicts risks that are likely to occur in the vehicle and provides warnings thereof based on information obtained by the camera C1, the LIDAR LD1, and the vehicle speed sensor 130, and a control module 170 that perceives a speed bump ahead on the path on which the vehicle is running through the camera C1 or the LIDAR LD1 and predicts the time point when the vehicle passes over the speed bump through the vehicle speed sensor 130 to prevent the operation of the impact event sensing module 140 based on the predicted time point so that the videos obtained by the camera C1 are prevented from being stored in the video recording module 150 in an impact event mode.

The description of the aforementioned components has been limited to some functions of the components, focusing on the process of preventing the function to start recording when an impact event occurs while a vehicle is passing over a speed bump, and no description of usual functions performed by the components has been provided.

In addition, it should be noted that the modules may each include a memory in which a program for performing a corresponding module's function is stored and a processor for executing the program and that the memories of the modules may be integrated into one or more memories and the processors thereof may be integrated into one or more processors.

Hereinafter, the process of operating the above-described system for handling an impact event when passing over a speed bump according to the present disclosure will be examined with reference to FIG. 2. The FIG. 2 shows an example of a flowchart for the process of operating a mode (herein after ‘speed bump mode’) for preventing an event recording for impacts caused by speed bumps. At S101, the control module 170 may determine whether a driver has set a setting to prevent recording of impacts caused by a speed bump, i.e. the control module 170 determines whether the speed bump mode is selected by a driver. Though it is not shown in FIG. 2, the event recording mode may have been selected by the driver in advance. A video around the vehicle may be recorded whenever a preset event occurs in the event recording mode.

When it is determined that the setting to prevent recording of impacts caused by a speed bump has been set at S101, proceeding to S102, it may be determined whether there is a speed bump ahead on a path on which a vehicle is running.

Here, the means for determining whether there is a speed bump at S102 may be referred to as a means for perceiving a speed bump, and the means for perceiving a speed bump may be on the basis of the camera video processing module 110 that analyzes the videos obtained by the camera C1 and determines whether there is a speed bump.

In addition, the means for perceiving a speed bump may be on the basis of the LIDAR signal processing module 120 that analyzes and processes signals sensed by at least one LIDAR scanning the front of the vehicle to determine whether there is a speed bump in front of the vehicle.

Therefore, the means for perceiving a speed bump may be based on a camera or a LIDAR, but is not limited thereto. It should be noted that, when a navigation system based on ultra-precise maps is provided, the means for perceiving a speed bump may determine whether there is a speed bump based on the information obtained by the navigation system.

Thereafter, when it is determined that there is a speed bump ahead on the path on which the vehicle is traveling at S103, proceeding to S104, the distance to the speed bump may be calculated. At S105, in order to predict the time point when the vehicle passes over the speed bump, the time point when the vehicle reaches the speed bump may be calculated by linking the information on the current speed of the vehicle (based on the signals sensed by the vehicle speed sensor 130) with the information on the calculated distance to the speed bump.

Then, at S106, through the ADAS 160, it may be determined whether an event is likely to occur while the vehicle is driving to the speed bump and whether there is anything that needs to be recorded, and the ADAS 160 may receive information on nearby objects through front and rear sensors and by sensing sudden stops and starts.

That is, at S107, it may be determined, through the ADAS 160, whether there is an object expected to approach the vehicle at an earlier time point close to the time point when the vehicle passes over the speed bump while it is driving to the speed bump. In addition, the ADAS 160 may receive information on the distance to objects close to the front/rear of the vehicle, in other words, may determine the distance through cameras, radars, etc., and the limit of the distance to a nearby object may be set by a designer.

For example, assuming that the limit of the distance between an object and a vehicle body is two meters, when the distance between the object and the vehicle body is equal to or greater than two meters, the object may be disregarded. However, when the distance between the object and the vehicle body is less than or equal to two meters, proceeding to S108, the speed bump mode may be turned off, and the event recording mode may be controlled to be continuously on.

In addition, at S109, the ADAS 160 may receive an alert on the risk of an approaching object or collision sensed by a rear/side sensor and a front sensor, and, when such a risk has been sensed, proceeding to S108, the mode for preventing recording of impacts caused by speed bumps may be turned off, and the mode for recording impact events may be controlled to be continuously on.

Furthermore, when it is determined that there has been a sudden stop or acceleration based on the variance in the signals sensed and output by the vehicle speed sensor 130 at S110, that is, when it is determined that the variance in the signals sensed by the vehicle speed sensor 130 indicates a sudden stop or acceleration based on the parameters set by the designer while the vehicle is approaching the speed bump, proceeding to S108, the mode for preventing recording of impacts caused by speed bumps may be turned off, and the mode for recording impact events may be controlled to be continuously on.

Accordingly, when it is determined that there are risk factors affecting the safe operation of the vehicle at any one of S107, S109, and S110, proceeding to S108, the mode for preventing recording of impacts caused by speed bumps may be turned off, and the mode for recording impact events may be controlled to be continuously on.

In contrast, when it is determined that there is no risk factor, the process may proceed to S111 to carry out the operation of the G value filtering counter according to a time range that has been set for maintaining the speed bump mode. In addition, when the designer has set the time to reach a speed bump to X sec at S111, the G values of the impacts received during the time ranging from X−y sec to X+y sec may be ignored at S112.

However, when a G value equal to or higher than the threshold set by the designer is applied, bypassing may be performed, and videos may be recorded when an impact occurs while the vehicle is driving (when a very strong impact occurs, videos may be recorded regardless of speed bumps).

Then, at S113, after the vehicle has passed over the speed bump, the G-filtering counter may be reset, and the control operation may end. In other words, at the time of X+y sec, the speed bump mode may be turned off, and the event recording mode may be controlled to be continuously on.

Therefore, according to the present disclosure, it may be possible to resolve the problem of important videos of accidents being deleted due to memory overload as too many videos are recorded due to impacts caused by speed bumps while a vehicle is driving.

The desirable embodiments of the present disclosure have been shown and described, but the present disclosure is not limited to the specific embodiments described above. It is needless to say that various modifications can be made to the present disclosure within the gist of the present disclosure claimed in the appended claims by a person having ordinary skill in the art, and such modifications should not be understood separately from the technology of the present disclosure.

The foregoing descriptions of the specific exemplary embodiments of the present disclosure have been presented for the purposes of illustration and description. They are not intended to be exhaustive or to limit the present disclosure to the precise forms disclosed, and obviously many modifications and variations are possible in light of the above-described teachings. The exemplary embodiments were chosen and described to explain certain principles of the present disclosure and their practical application, to enable others skilled in the art to make and utilize the various exemplary embodiments of the present disclosure, as well as various alternatives and modifications thereof. It is intended that the scope of the present disclosure be defined by the claims appended hereto and their equivalents.

What is claimed is:

1. A method of recording videos around a vehicle, comprising:
activating an event recording mode to record a video around the vehicle as a preset impact event occurs,
perceiving a speed bump ahead on a path on which the vehicle is running,
predicting a time point when the vehicle passes over the speed bump, and
disregarding an impact event for the event recording mode based on the predicted time point.

2. The method of claim 1, wherein the perceiving of a speed bump includes obtaining an image of a front view from the vehicle by use of at least one camera and processing the image to determine whether there is a speed bump.

3. The method of claim 1, wherein the perceiving of a speed bump includes determining whether there is a speed bump ahead through at least one LIDAR and by processing a signal sensed by the LIDAR.

4. The method of claim 1, wherein the predicting of the time point includes determining a distance between the perceived speed bump and a current location of the vehicle and determining a time point when the vehicle reaches the speed bump based on the calculated distance and a speed of the vehicle.

5. The method of claim 1, wherein the disregarding of an impact event includes determining that there is an object expected to approach the vehicle at an earlier time point than the predicted time point.

6. The method of claim 1, wherein the disregarding of an impact event includes determining that an alert on an approaching or collision-risky object is issued by the vehicle at an earlier time point than the predicted time point.

7. The method of claim 1, wherein the disregarding of an impact event includes determining that there is a sudden stop or start of the vehicle at an earlier time point than the predicted time point.

8. The method of claim 7, wherein the determining that there is a sudden stop or start of the vehicle is based on a variance in a speed of the vehicle.

9. The method of claim 1, wherein the disregarding of an impact event comprises:
determining that at least one condition is met, and
halting the event recording mode,
wherein the at least one condition is one of: i) there being an object expected to approach the vehicle at an earlier time point than the predicted time point, ii) an alert on an approaching or collision-risky object being issued by the vehicle at an earlier time point than the predicted time point; and iii) there being a sudden stop or start of the vehicle at an earlier time point than the predicted time point.

10. The method of claim 1, wherein the disregarding of an impact event comprises ignoring an impact exceeding a reference point for the event recording mode.

11. A system for recording videos around a vehicle, comprising:
a vehicle speed sensor configured to sense a speed of the vehicle,
an impact event sensing module configured to determine whether an impact exceeding a reference point has occurred in the vehicle,
a video recording module configured to store videos obtained by at least one camera,
an advanced driver assistance system configured to predict risks that are likely to occur to the vehicle, and
a control module configured to:
activate an event recording mode to record a video around the vehicle as an impact event occurs;
perceive a speed bump ahead on a path on which the vehicle is running and predict a time point when the vehicle passes over the speed bump; and
disregard an impact event for the event recording mode based on the predicted time point.

12. The system of claim 11, wherein the control module is further configured to process an image of a front view of the vehicle obtained by at least one camera and determine whether there is the speed bump.

13. The system of claim 11, wherein the control module is further configured to perceive the speed bump by use of at least one LIDAR configured to scan a front view of the vehicle.

14. The system of claim 11, wherein the control module is further configured to calculate a distance between the perceived speed bump and a current location of the vehicle and calculate a time point when the vehicle reaches the speed bump based on the calculated distance and a speed of the vehicle.

15. The system of claim 11, wherein the control module is further configured to that there is an object expected to approach the vehicle at an earlier time point than the predicted time point.

16. The system of claim 11, wherein the control module is further configured to determine that an alert on an approaching or collision-risky object is issued by the vehicle at an earlier time point than the predicted time point.

17. The system of claim 11, wherein the control module is further configured to determine that there is a sudden stop or start of the vehicle at an earlier time point than the predicted time point.

18. The system of claim 11, wherein the control module is further configured to:
determine that at least one condition is met, and
halt the event recording mode,
wherein the at least one condition is one of: there being an object expected to approach the vehicle at an earlier time point than the predicted time point; an alert on an approaching or collision-risky object being issued by the vehicle at an earlier time point than the predicted time point; or there being a sudden stop or start of the vehicle at an earlier time point than the predicted time point.

19. The system of claim 11, wherein the control module is further configured to ignore an impact exceeding the reference point for the event recording mode.

20. A vehicle comprising:
a vehicle speed sensor configured to sense a speed of the vehicle,
an impact event sensing module configured to determine whether an impact exceeding a reference point has occurred in the vehicle,
a video recording module configured to store videos obtained by at least one camera,
an advanced driver assistance system configured to predict risks that are likely to occur to the vehicle, and
a control module configured to:
activate an event recording mode to record a video around the vehicle as a preset event occurs;
perceive a speed bump ahead on a path on which the vehicle is running and predict a time point when the vehicle passes over the speed bump; and
disregard an impact event based on the predicted time point for the event recording mode.
